(19) United States
(12) Patent Application Publication
(10) Pub. No.: US 2010/0134481 A1
(43) Pub. Date: Jun. 3, 2010

(54) PLASMA DISPLAY DEVICE AND METHOD OF DRIVING THE SAME

(76) Inventors: Sung-Im Lee, Suwon-si (KR); Hak-Cheol Yang, Suwon-si (KR)

Correspondence Address: CHRISTIE, PARKER & HALE, LLP, PO BOX 7068, PASADENA, CA, 91109-7068, US

(21) Appl. No.: 12/622,879

(22) Filed: Nov. 20, 2009

(30) Foreign Application Priority Data
Nov. 28, 2008 (KR) 10-2008-0119999

(51) Int. Cl. G06F 3/038; G09G 3/28

(52) U.S. Cl. 345/214; 345/60

(57) ABSTRACT

In a plasma display device, a first driving method or a second driving method is selected according to a video signal, and the plasma display device is driven according to the selected driving method. The first driving method includes selecting first on cells from among a plurality of discharge cells in an address period of a first subfield of a plurality of subfields, and selecting second on cells in an address period of each of a plurality of second subfields from among the plurality of discharge cells other than discharge cells selected as on cells in preceding subfields. The second driving method includes initializing the plurality of discharge cells as off cells in a reset period of each of the plurality of subfields, and selecting on cells from among the plurality of discharge cells in an address period of each of the plurality of subfields following the corresponding reset period.

### CROSS-REFERENCE TO RELATED APPLICATION

This application claims priority to and the benefit of Korean Patent Application No. 10-2008-0119999 filed in the Korean Intellectual Property Office on Nov. 28, 2008, the entire contents of which are incorporated herein by reference.

### BACKGROUND OF THE INVENTION

1. Field of the Invention

The present invention relates to a plasma display device and a method of driving the same.

2. Description of the Related Art

A plasma display device is a display device utilizing a plasma display panel (PDP) for displaying text or images using plasma generated by gas discharge. In the PDP, a plurality of discharge cells are arranged in a matrix format.

In the plasma display device, a field is divided into a plurality of subfields having respective weight values to be driven, and gray levels are displayed by utilizing a combination of weight values of subfields that perform a display operation among the plurality of subfields. In an address period of each subfield, on cells and off cells are selected. In a sustain period, the on cells are sustain-discharged for a period corresponding to a weight value of the corresponding subfield and an image is displayed.

However, in a case of using subfields having weight values that are powers of 2, a dynamic false contour occurs in certain instances. For example, when one discharge cell expresses a gray level of 127 and a gray level of 128 in two continuous frames, respectively, a dynamic false contour occurs.

In each subfield, a discharge cell is set as an on cell by an address discharge, and when a frame includes eight subfields, address discharge may be performed up to 8 times in one discharge cell. Thus, power consumption due to address discharge (hereinafter referred to as “address power consumption”) is high.

### SUMMARY OF THE INVENTION

According to exemplary embodiments, a plasma display device for reducing address power consumption and/or dynamic false contour, and a method of driving the same, are provided.

An exemplary embodiment provides a method of driving a plasma display device including a plurality of discharge cells, in which one field includes a plurality of subfields including a first subfield and a plurality of second subfields after the first subfield. The method includes selecting a first driving method or a second driving method according to a video signal, and driving the plasma display device according to the selected driving method. The first driving method includes selecting first on cells from among the plurality of discharge cells in an address period of the first subfield, and selecting second on cells in an address period of each of the plurality of second subfields from among the plurality of discharge cells other than discharge cells selected as on cells in preceding subfields of the corresponding field. The second driving method includes initializing the plurality of discharge cells as off cells in a reset period of each of the plurality of subfields, and selecting on cells from among the plurality of discharge cells in an address period of each of the plurality of subfields following the corresponding reset period.

Another exemplary embodiment provides a method of driving a plasma display device including a plurality of first electrodes, a plurality of second electrodes, and a plurality of discharge cells aligned with the plurality of first electrodes and the plurality of second electrodes. The method includes: selecting first on cells from among the plurality of discharge cells in an address period of a first subfield of a first field, the first field comprising the first subfield and a plurality of second subfields after the first subfield; sustain-discharging the first on cells in a sustain period of the first subfield; selecting second on cells in an address period o feach of the plurality of second subfields from among the plurality of discharge cells other than discharge cells selected as on cells in preceding subfields of the first field; and in a sustain period of each of the plurality of second subfields, sustain-discharging on cells from preceding subfields and the second on cells selected in the address period of the corresponding subfield.

The sustain-discharging includes applying a first high-level voltage to the second electrodes while applying a first low-level voltage to the first electrodes during a first period, and gradually increasing a voltage of the second electrodes from a first voltage to a second voltage higher than the first high-level voltage while applying the first low-level voltage to the first electrodes during a second period after the first period.

The sustain-discharging may further include applying a second high-level voltage higher than the first low-level voltage to the first electrodes and applying a second low-level voltage lower than the first high-level voltage to the second electrodes during a third period after the second period, and gradually decreasing a voltage of the second electrodes from a fourth voltage to a fifth voltage lower than the second low-level voltage while applying a third voltage higher than the first low-level voltage to the first electrodes during a fourth period after the third period.

Yet another exemplary embodiment provides a plasma display device including a plurality of first electrodes, a plurality of second electrodes, a plurality of discharge cells aligned with the first electrodes and the second electrodes, a controller for dividing one field into a plurality of subfields including a first subfield and a plurality of second subfields after the first subfield, and for selecting a first driving method or a second driving method according to a video signal, and at least one driver for driving the first electrodes and the second electrodes according to the selected driving method. When the first driving method is selected, the at least one driver is configured to select on cells from among the plurality of discharge cells after initializing the plurality of discharge cells as off cells in the first subfield, and to select on cells in each of the plurality of second subfields from among the plurality of discharge cells other than discharge cells selected as on cells in preceding subfields of the corresponding field. When the second driving method is selected, the at least one driver is configured to select on cells from among the plurality of discharge cells after initializing the plurality of discharge cells as off cells in each of the plurality of subfields.

### BRIEF DESCRIPTION OF THE DRAWINGS

FIG. 1 is a schematic block diagram of a plasma display device according to an exemplary embodiment.

FIG. 2 is a diagram schematically illustrating a method of driving a plasma display device according to an exemplary embodiment.

FIG. 3 is a diagram illustrating a method of expressing gray levels of a plasma display device according to an exemplary embodiment.

FIGS. 4 and 5 are diagrams illustrating driving waveforms of a plasma display device according to an exemplary embodiment.

FIGS. 6 and 7 are diagrams illustrating driving waveforms of a plasma display device according to another exemplary embodiment.

FIG. 8 is a diagram illustrating an example of a binary driving method of a plasma display device.

FIG. 9 is a diagram illustrating a method of expressing gray levels of a plasma display device according to a binary driving method.

FIG. 10 is a schematic block diagram of a controller of a plasma display device according to another exemplary embodiment.

### DETAILED DESCRIPTION OF EXEMPLARY EMBODIMENTS

Hereinafter, exemplary embodiments of the present invention are described in detail, with reference to the appended drawings, so as to enable one of ordinary skill in the art to which the invention pertains to practice the invention. However, the present invention may be embodied in various different forms, and is not limited to the described embodiments. Also, in order to describe the present invention clearly, some parts that are unrelated to the description have been omitted from the drawings, and like reference numerals designate like elements throughout the specification.

In the specification, unless explicitly stated otherwise, when an element is said to be “comprised” or “included”, it does not mean that other elements are excluded but rather encompasses the possibility of other elements being further included. Further, a wall charge is a charge formed on a cell wall (e.g., a dielectric layer) close to each respective electrode. Wall charges do not actually contact electrodes, but will be described as “formed”, “accumulated”, or “built up” at or on the electrodes. Also, a wall voltage refers to a potential difference formed at a cell wall due to a wall charge.

A plasma display device and a method of driving the same according to exemplary embodiments of the present invention will now be described in detail with reference to the drawings.

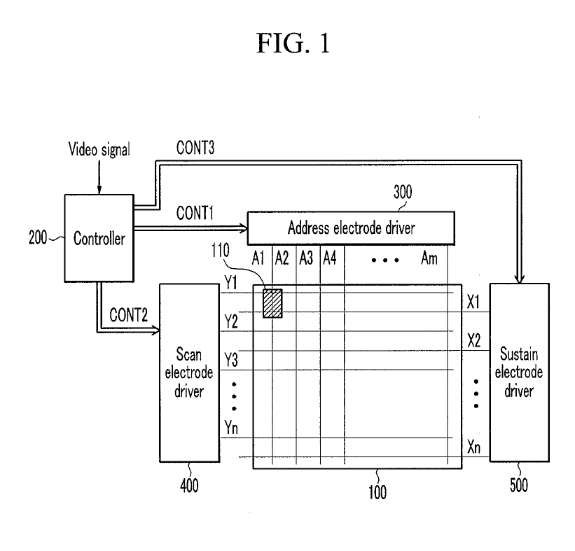

FIG. 1 is a schematic block diagram of a plasma display device according to an exemplary embodiment.

Referring to FIG. 1, the plasma display device includes a PDP 100, a controller 200, an address electrode driver 300, a scan electrode driver 400, and a sustain electrode driver 500.

The PDP 100 includes a plurality of address electrodes (hereinafter referred to as “A electrodes”) A1-Am that extend in a column direction, and a plurality of sustain electrodes (hereinafter referred to as “X electrodes”) X1-Xn and a plurality of scan electrodes (hereinafter referred to as “Y electrodes”) Y1-Yn that are arranged in pairs and extend in a row direction. The X electrodes X1-Xn are formed to correspond to the Y electrodes Y1-Yn, respectively, and the X electrodes and the Y electrodes perform a display operation for displaying an image in a sustain period. The Y electrodes Y1-Yn and the X electrodes X1-Xn are disposed to be substantially orthogonal to the A electrodes A1-Am. Here, discharge spaces at crossing regions of the A electrodes A1-Am, the X electrodes X1-Xn, and the Y electrodes Y1-Yn form discharge cells 110. Such a structure of the PDP 100 is one example, and panels of other structures in which a driving waveform to be described later may be applied may also be utilized in the present invention.

The controller 200 receives a video signal and an input control signal that controls display of the video signal. The video signal contains luminance information of each discharge cell 110, where luminance corresponds to a predetermined number of gray levels. The controller 200 divides one field that displays an image into a plurality of subfields that each have a weight value, and each subfield includes an address period and a sustain period. The controller 200 processes the video signal and the input control signal to correspond to a plurality of subfields, thereby generating an A electrode driving control signal CONT1, a Y electrode driving control signal CONT2, and an X electrode driving control signal CONT3. The controller 200 outputs the A electrode driving control signal CONT1 to the address electrode driver 300, the Y electrode driving control signal CONT2 to the scan electrode driver 400, and the X electrode driving control signal CONT3 to the sustain electrode driver 500.

The address electrode driver 300 applies a driving voltage to the A electrodes A1-Am according to the A electrode driving control signal CONT1 from the controller 200.

The scan electrode driver 400 applies a driving voltage to the Y electrodes Y1-Yn according to the Y electrode driving control signal CONT2 from the controller 200.

The sustain electrode driver 500 applies a driving voltage to the X electrodes X1-Xn according to the X electrode driving control signal CONT3 from the controller 200.

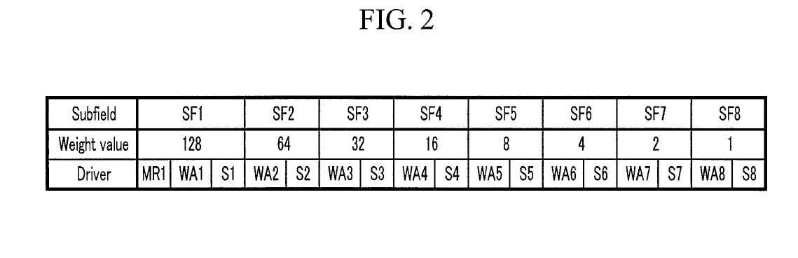

Next, a method of driving a plasma display device according to an exemplary embodiment will be described in detail with reference to FIG. 2.

FIG. 2 is a diagram schematically illustrating a method of driving a plasma display device according to an exemplary embodiment. In FIG. 2, it is assumed that one field includes eight subfields.

Referring to FIG. 2, one field includes a plurality of subfields SF1-SF8, and the plurality of subfields SF1-SF8 have weight values of 128, 64, 32, 16, 8, 4, 2, and 1, respectively. One subfield SF1 among the plurality of subfields SF1-SF8 includes a reset period MR1, an address period WA1, and a sustain period S1, and the remaining subfields SF2-SF8 include address periods WA2-WA8 and sustain periods S2-S8. The address periods WA1-WA8 of the subfields SF1-SF8 use a selective write method.

The selective write method is a method of forming wall voltages by discharging selected discharge cells to set those discharge cells as on cells, in order to select on cells and off cells among a plurality of discharge cells. In the selective write method, off cells are address-discharged to form wall charges to set those cells as on cells, where the address discharge for forming wall charges is called a “write discharge.”

The subfield SF1 having an address period of a selective write method has a reset period MR1 that sets all discharge cells to off cells by initialization. That is, in the reset period MR1 of the subfield SF1, all discharge cells are set to off cells by initialization, and in the address period WA1, wall charges are formed by write-discharging discharge cells to be set as on cells among the plurality of discharge cells. The on cells are sustain-discharged in a sustain period S1. In one embodiment, the subfield SF1 is positioned at the forefront of the plurality of subfields SF1-SF8, and has the largest weight value of 128.

The remaining subfields SF2-SF8 do not have a reset period MR1. That is, in the address periods WA2-WA8 of the subfields SF2-SF8, wall charges are formed by write-discharging discharge cells to be set as on cells among the remaining discharge cells that were not previously set as on cells in address periods WA1-WA7 of immediately preceding subfields SF1-SF7. In the sustain periods S2-S8, on cells are sustain-discharged. In this case, because discharge cells that have been set as on cells in the address periods WA1-WA7 of the previous subfields SF1-SF7 remain in the on cell state, those discharge cells continue to sustain-discharge even in the sustain periods S2-S8 of the subfields SF2-SF8.

Accordingly, because discharge cells that are set as on cells by write discharge in any one subfield remain in the on cell state even in the following subfield, those discharge cells continue to sustain-discharge even in a sustain period of the following subfield. In this case, the number of times a sustain discharge is generated in a sustain period is set differently according to a weight value of the corresponding subfield, and in an exemplary embodiment, subfields are arranged in order of descending weight value.

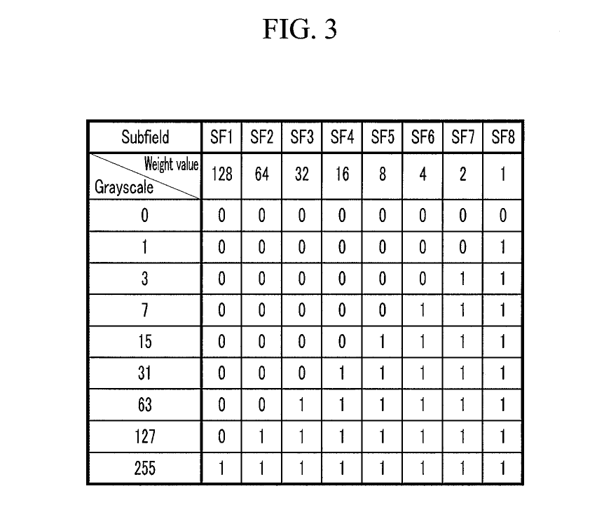

Next, a method of expressing gray levels by the method of FIG. 2 will be described with reference to FIG. 3.

FIG. 3 is a diagram illustrating a method of expressing gray levels of a plasma display device according to an exemplary embodiment.

In FIG. 3, “1” indicates a subfield in which discharge cells are in the on cell state, and “0” indicates a subfield in which discharge cells are in the off cell state.

Referring to FIG. 3, when a discharge cell becomes an on cell by a write discharge in the address period WA1 of the first subfield SF1, it remains in the on cell state even in the following subfields SF2-SF8, and thus the discharge cell expresses a gray level of 255 (=128+64+32+16+8+4+2+1). When a discharge cell becomes an on cell by performing a write discharge in an address period WA7 of the seventh subfield SF7 without a previous write discharge in address periods WA1-WA6 of the first to sixth subfields SF1-SF6, it remains in an on cell state in an eighth subfield SF8, and thus it can express a gray level of 3 (=2+1). Similarly, when a discharge cell does not write discharge in address periods WA1-WA7 of the first to seventh subfields SF1-SF7 but performs a write discharge in an address period WA8 of an eighth subfield SF8, it can express a gray level of 1.

Accordingly, the plasma display device according to an exemplary embodiment can express gray levels of 0, 1, 3, 7, 15, 31, 63, 127, and 255 with combinations of the subfields SF1-SF8. In this case, the controller 200 can express gray levels that cannot be expressed with a combination of the subfields SF1-SF8 by applying a half-toning process, for example a dithering process, with respect to gray levels of 0, 1, 3, 7, 15, 31, 63, 127, and 255.

In contrast, by arranging the plurality of subfields SF1-SF8 in order of ascending weight value, gray levels of 255, 254, 252, 248, 240, 224, 192, 128, and 0 can be expressed by combinations of the subfields SF1-SF8. Therefore, in contrast to this case, the case of arranging the subfields in order of descending weight value as shown in FIGS. 2 and 3 enables low gray levels to be more efficiently and effectively expressed.

According to an exemplary embodiment, as a gray level is expressed by a combination of weight values of a series of subfields starting from a subfield in which discharge cells are set to an on cell state by write discharge, a dynamic false contour does not occur. Also, a discharge cell that is set to an on cell state by write discharge in any one subfield continues to maintain the on cell state in the following subfields, so no matter what gray level is expressed, an address discharge is generated only once in address periods of the subfields included in one frame. Therefore, power consumption due to address discharge decreases, and the number of times the address electrode driver 300 switches a switch for applying a driving voltage to the A electrodes decreases so that address switching heat emission decreases. Further, because not all subfields SF1-SF8 have a reset period and one field has only one reset period MR1, the contrast ratio can be improved.

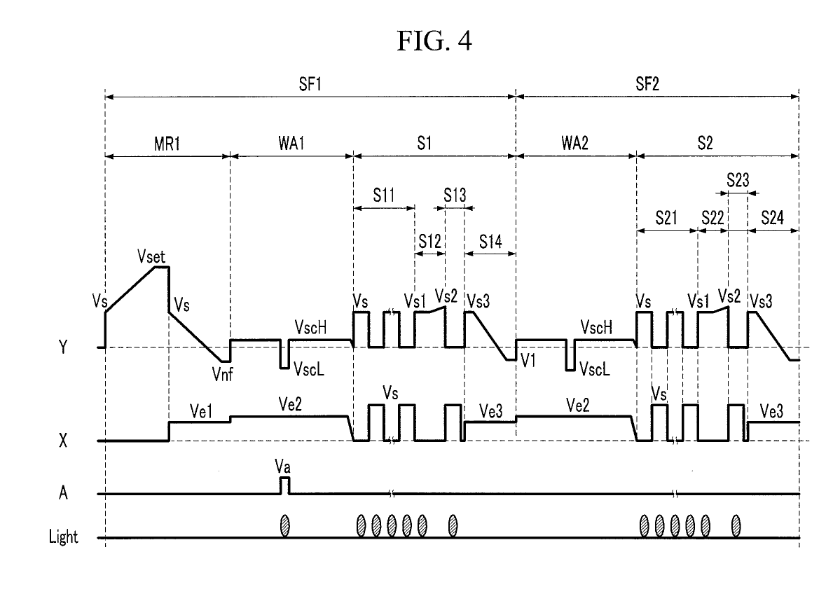

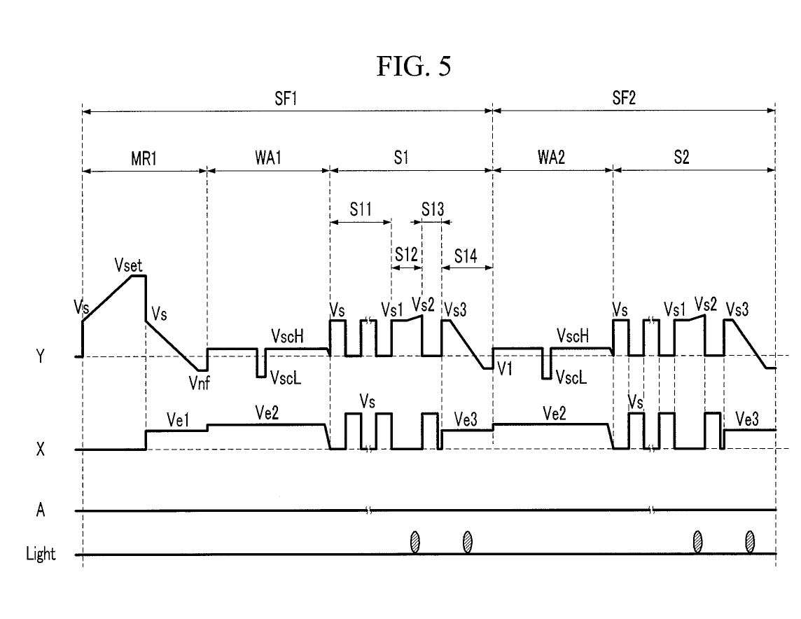

Next, driving waveforms that are used in a method of driving a plasma display device according to an exemplary embodiment will be described in detail with reference to FIGS. 4 and 5.

FIGS. 4 and 5 are diagrams illustrating driving waveforms of a plasma display device according to an exemplary embodiment.

FIG. 4 is a diagram illustrating a waveform that is applied to a discharge cell in which a write discharge is generated in an address period, and FIG. 5 is a diagram illustrating a waveform that is applied to a discharge cell in which a write discharge is not generated in an address period. In FIGS. 4 and 5, for better understanding and ease of description, only the first and second subfields SF1 and SF2 have been illustrated.

Referring to FIGS. 4 and 5, in the reset period MR1 of the first subfield SF1, when a reference voltage (0V in FIG. 4) is applied to the X electrodes and the A electrodes, the voltage of the Y electrodes gradually increases from a voltage Vs to a voltage Vset. Accordingly, while the voltage of the Y electrodes increases, a weak reset discharge is generated between the Y electrodes and the X electrodes, and between the Y electrodes and the A electrodes, and wall charges are formed in all discharge cells. In FIGS. 4 and 5, the voltage of the Y electrodes gradually increases from the voltage Vs, but the voltage of the Y electrodes may gradually increase from a voltage that is different from the voltage Vs, for example from a voltage VscH-VscL corresponding to the difference between a voltage VscH and a voltage VscL to be described later.

Thereafter, when a voltage Ve1 is applied to the X electrodes and a reference voltage is applied to the A electrodes, the voltage of the Y electrodes gradually decreases from the voltage Vs to a voltage Vnf. Accordingly, while the voltage of the Y electrodes decreases, a weak reset discharge is generated between the Y electrodes and the X electrodes, and between the Y electrodes and the A electrodes, and some or all of the wall charges formed in the discharge cells are erased so that all discharge cells are initialized to off cells. The magnitude of a voltage Vnf-Ve1 may be set at about a discharge firing voltage between the Y electrodes and the X electrodes. Accordingly, after termination of the reset period MR1, a wall voltage between the Y electrodes and the X electrodes becomes almost 0V such that off cells in which a write discharge is not generated in an address period can be prevented from misfiring in a sustain period, and an address discharge can be easily generated. In FIGS. 4 and 5, the voltage of the Y electrodes gradually decreases from the voltage Vs, but in some embodiments, the voltage of the Y electrodes may gradually decrease from a different voltage, for example from 0V.

In an address period WA1, when a voltage Ve2 that is higher than a voltage Ve1 is applied to the X electrodes, scan pulses of the voltage VscL are sequentially applied to a plurality of Y electrodes. Alternatively, in the address period WA1, the voltage Ve1 may be applied to the X electrodes. As shown in FIG. 4, address pulses of a voltage Va are applied to the A electrodes of discharge cells to be set as on cells among discharge cells that are formed by the Y electrodes to which scan pulses are applied. In contrast, as shown in FIG. 5, a reference voltage is applied to the A electrodes of discharge cells to be set as off cells among discharge cells that are formed by the Y electrodes to which scan pulses are applied. Accordingly, as a write discharge is generated in discharge cells to which the VscL scan pulse and the Va address pulse are applied, a wall voltage is formed at the X electrodes and the Y electrodes and the discharge cells become on cells. The voltage VscH that is higher than the voltage VscL is applied to the Y electrodes to which the scan pulse is not applied, and a reference voltage is applied to the A electrodes to which address pulse is not applied.

In some period S11 of the sustain period S1, sustain pulses having a high-level voltage (the voltage Vs in FIG. 4) and a low-level voltage (0V in FIG. 4) are alternately applied to the Y electrodes and the X electrodes such that the on cells are sustain-discharged.

That is, when the voltage Vs is applied to the Y electrodes, 0V is applied to the X electrodes, and when the voltage Vs is applied to the X electrodes, 0V is applied to the Y electrodes. In this case, a sustain discharge is generated only in the on cells in which a write discharge was generated in the address period WA1. As shown in FIG. 5, a sustain discharge is not generated in off cells in which a write discharge was not generated in the address period WA1. Such sustain pulses are alternately applied to the Y electrodes and the X electrodes a number of times corresponding to a weight value of the corresponding subfield SF1.

In another period S12 of the sustain period S1, when 0V is applied to the X electrodes, a voltage Vs1 is applied to the Y electrodes and the voltage of the Y electrodes gradually increases from the voltage Vs1 to a voltage Vs2. In this case, the voltage Vs1 may be set to be equal to the voltage Vs. Accordingly, as shown in FIG. 4, when the voltage Vs1 is applied to the Y electrodes, a sustain discharge is generated between the Y electrodes and the X electrodes of the on cells, and thus negative wall charges are formed at the Y electrodes and positive wall charges are formed at the X electrodes. In this case, even if the voltage of the Y electrodes increases from the voltage Vs1 to the voltage Vs2, negative wall charges have already fully formed at the Y electrodes, and thus a discharge is not generated between the Y electrodes and the X electrodes while the voltage of the Y electrodes gradually increases.

However, in the off cells, when the voltage Vs1 is applied to the Y electrodes, a discharge is not generated. In this case, in the off cells, because a wall voltage between the Y electrodes and the X electrodes approaches about 0V, while the voltage of the Y electrodes gradually increases up to the voltage Vs2, only a feeble or slight discharge may be generated between the Y electrodes and the X electrodes in the off cells. Accordingly, negative wall charges are formed at the Y electrodes to which the voltage Vs2 is applied, and positive wall charges are formed at the X electrodes to which 0V is applied.

Here, the voltage Vs2 is set as a voltage to generate a discharge between the Y electrodes and the X electrodes in the off cells. The voltage Vs2 is a value that can be set by a person of ordinary skill in the art through experimentation. For example, it may be set to a voltage that is a little higher than a discharge firing voltage between the Y electrodes and the X electrodes. When wall charge loss occurs in a wall charge state that is set in a reset period MR1, even if the voltage Vs2 is set to a discharge firing voltage or less between the Y electrodes and the X electrodes, a discharge may be generated in the off cells. In this case, because negative wall charges are additionally formed at the Y electrodes by the voltage Vs2, a wall charge loss may be compensated.

Next, in another period S13 of the sustain period S1, the voltage Vs is applied to the X electrodes and 0V is applied to the Y electrodes. Accordingly, as a sustain discharge is generated in the on cells, positive wall charges are formed at the Y electrodes and negative wall charges are formed in the X electrodes. In this case, in the off cells, because less wall charges are formed, a sustain discharge is not generated.

In another period S14 of the sustain period S1, when a voltage Ve3 is applied to the X electrodes, the voltage of the Y electrodes gradually decreases from a voltage Vs3 to the voltage V1. Accordingly, as shown in FIG. 5, in the off cells, a weak discharge is generated between the Y electrodes and the X electrodes while the voltage of the Y electrodes gradually decreases due to negative wall charges formed at the Y electrodes and positive wall charges formed in the X electrodes. Accordingly, negative wall charges formed at the Y electrodes and positive wall charges formed at the X electrodes are erased.

In this case, the difference between the voltage Ve3 and the voltage V1 can be set to a voltage at which a discharge is not generated in the on cells and at which a discharge is generated due to negative wall charges formed at the Y electrodes and positive wall charges formed at the X electrodes in the off cells. Particularly, for an address discharge in an address period of a next subfield, in order to set a state of the off cells to the same wall charge state as in the reset period MR1, the difference between the voltage Ve3 and the voltage V1 may be set to be equal to the difference between the Ve1 voltage and a voltage Vnf. For example, the voltage Ve3 and the voltage V1 may be set to be equal to the voltage Ve1 and the voltage Vnf, respectively.

Next, in an address period WA2 of the second subfield SF2, when the voltage Ve1 (or the voltage Ve2) is applied to the X electrodes, scan pulses of the voltage VscL are sequentially applied to the plurality of Y electrodes. Address pulses of the voltage Va are applied to the A electrodes of discharge cells to be set as on cells among discharge cells that are formed by the Y electrodes to which scan pulses are applied, and a reference voltage is applied to the A electrodes to which the voltage Va is not applied. While the scan pulses are applied to the Y electrodes of discharge cells that have been set as on cells in the previous subfield SF1, a reference voltage may also be applied to the A electrodes of those discharge cells.

Similarly to the first subfield SF1, in the sustain period S2 of the second subfield SF2, four periods S21, S22, S23, and S24 are performed so that a sustain discharge is generated in the on cells of the previous subfield SF1 and the discharge cells set as the on cells in the present subfield SF2. In this case, the number of sustain pulses that are applied in the period S21 is determined by the weight value of the corresponding subfield SF2.

Operation in the address periods WA3-WA8 and the sustain periods S3-S8 of the remaining subfields SF3-SF8 is similar to operation in the second subfield SF2, except for the number of discharge cells that are selected in the address periods WA3-WA8 and the number of sustain pulses that are applied in the sustain periods S3-S8, and thus a description thereof is omitted.

In this way, according to an exemplary embodiment, because a weak discharge is generated even in off cells in a sustain period, priming particles are formed in the off cells. Accordingly, even if no reset period exists in a next subfield, with the assistance of the priming particles, an address discharge can be easily generated in the off cells in a subsequent address period.

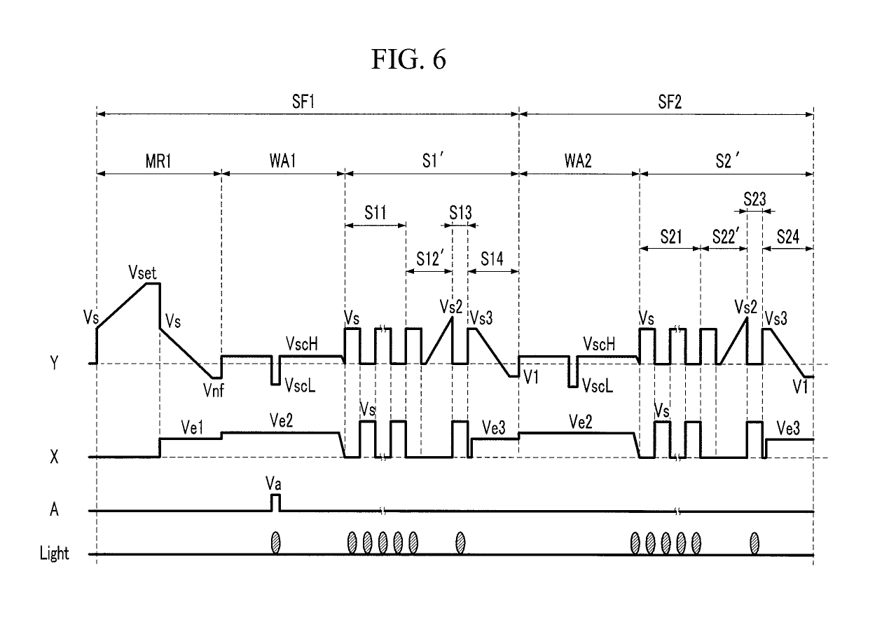

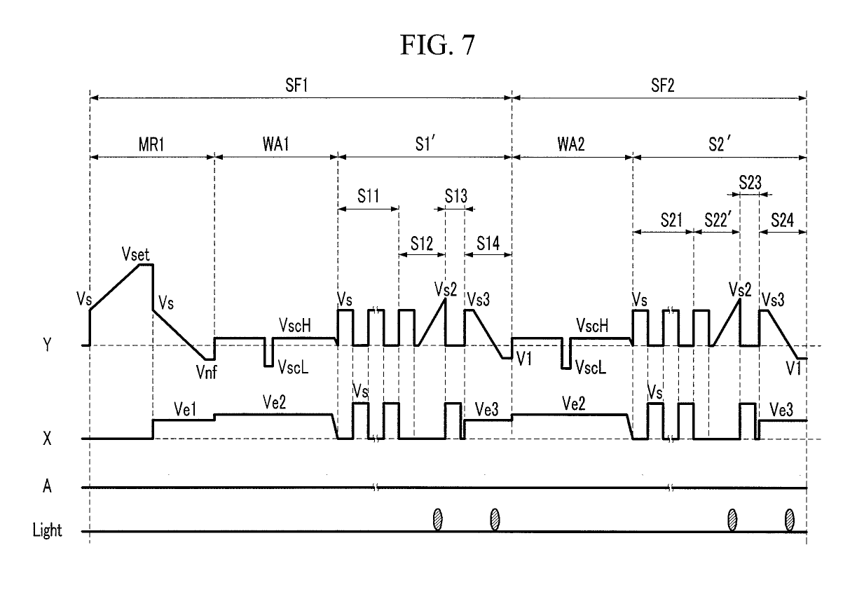

In an exemplary embodiment, in a period S12/S22 of the sustain period, after the voltage Vs1 that is equal to the voltage Vs is applied to the Y electrodes, the voltage of the Y electrodes increases from the voltage Vs1 to the voltage Vs2, but in other embodiments, the voltage Vs1 may be set to be different from the voltage Vs. Another exemplary embodiment will be described below with reference to FIGS. 6 and 7.

FIGS. 6 and 7 are diagrams illustrating driving waveforms of a plasma display device according to another exemplary embodiment.

FIG. 6 is a diagram illustrating a waveform that is applied to a discharge cell in which a write discharge is generated in an address period, and FIG. 7 is a diagram illustrating a waveform that is applied to a discharge cell in which a write discharge is not generated in an address period.

As shown in FIGS. 6 and 7, a driving waveform according to another exemplary embodiment is similar to that of the exemplary embodiment shown in FIGS. 4 and 5, except for a period S12′/S22′ of a sustain period.

Referring to FIGS. 6 and 7, in a second period S12′/S22′ of a sustain period S1′/S2′, after on cells are sustain-discharged by applying the voltage Vs to the Y electrodes and 0V to the X electrodes, the voltage of the Y electrodes gradually increases from 0V to the voltage Vs2. Accordingly, as described above, while the voltage of the Y electrodes gradually increases to the Vs2 voltage, a discharge is not generated in the on cells, but a weak discharge is generated in the off cells. Accordingly, negative wall charges are formed at the Y electrodes of the off cells, and positive wall charges are formed at the X electrodes.

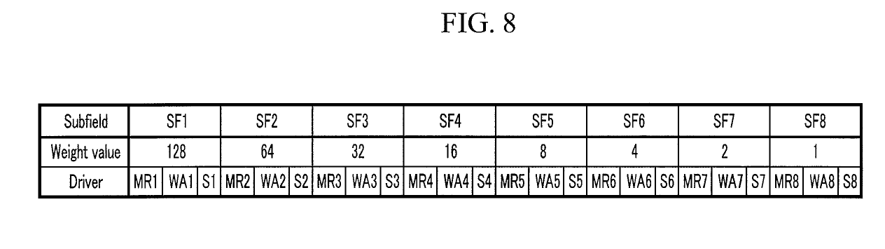

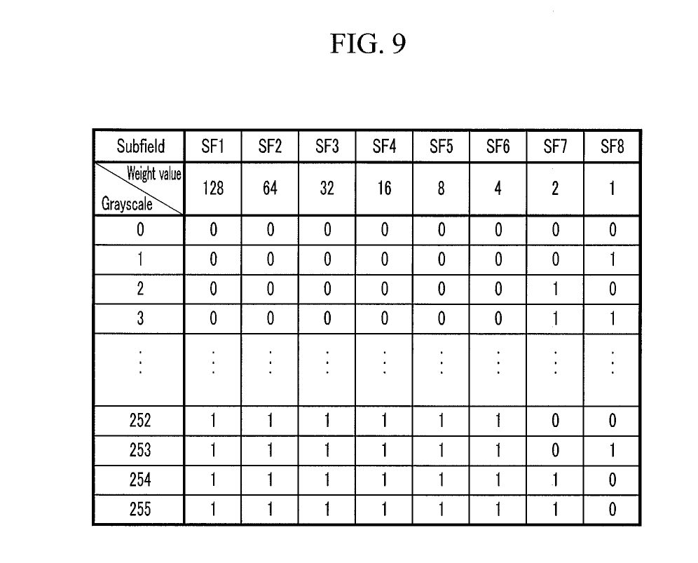

As shown in FIGS. 2 and 3, a driving method (hereinafter referred to as “contiguous driving method”) for allowing a discharge cell to contiguously emit light from any subfield to the final subfield has been described in the above exemplary embodiments. However, according to the input video signal, either the contiguous driving method or a driving method that is different from the contiguous driving method may be selected and applied. A binary driving method, which is an example of such a different driving method, will be described with reference to FIGS. 8 and 9.

FIG. 8 is a diagram illustrating an example of a binary driving method of a plasma display device, and FIG. 9 is a diagram illustrating a method of expressing gray levels of a plasma display device according to a binary driving method.

Referring to FIG. 8, the binary driving method is similar to the driving method that is shown in FIG. 2, except that a plurality of subfields SF1-SF8 have reset periods MR1-MR8.

The plurality of subfields SF1-SF8 include reset periods MR1-MR8 that initialize discharge cells to off cells, address periods WA1-WA8 that select on cells, and sustain periods S1-S8 that sustain-discharge the on cells according to a corresponding weight value. In this case, the reset periods MR1-MR8 may be a main reset period of initializing all discharge cells, or a part thereof may be a main reset period and the remaining part thereof may be a sub-reset period for initializing only on cells of an immediately preceding subfield.

Referring to FIG. 9, in a method of expressing gray levels according to a binary driving method, in an address period of each subfield, a write discharge can be selectively performed in discharge cells regardless of whether a write discharge is performed in the discharge cells in an immediately preceding subfield. That is, a gray level can be expressed by selecting each discharge cell in each subfield as either an on cell or an off cell and combining subfields in which each discharge cell is selected as an on cell. Accordingly, as shown in FIG. 9, in a binary driving method, since various gray levels from 0 to 255 may be expressed with combinations of subfields, expression of gray levels can be improved. Further, as each of the subfields SF1-SF8 has a reset period, unlike the exemplary embodiment illustrated in FIGS. 4 to 7, some periods S12 and S12′ may not be performed in the sustain periods in these embodiments.

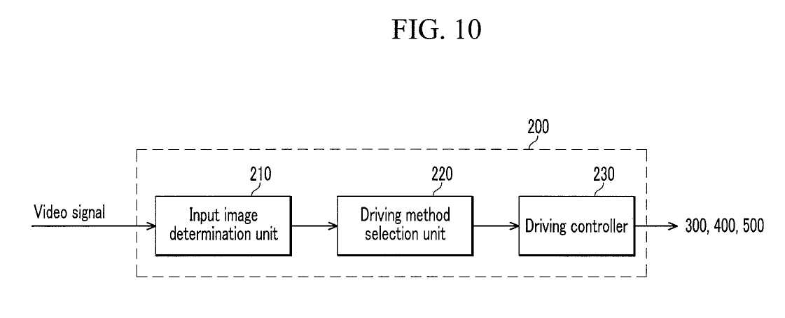

Next, an exemplary embodiment that selects between a contiguous driving method and a binary driving method according to the input video signal will be described in detail with reference to FIG. 10.

FIG. 10 is a schematic block diagram of a controller of a plasma display device according to another exemplary embodiment.

Referring to FIG. 10, a controller 200 includes an input image determination unit 210, a driving method selection unit 220, and a driving controller 230.

The input image determination unit 210 determines whether a video signal of at least one field is a video signal having high address power consumption according to a binary driving method. Here, address power consumption is power generated when applying address pulses to a plurality of address electrodes in order to select on cells and off cells in address periods of a plurality of subfields. Therefore, the input image determination unit 210 calculates address power consumption through subfield data when using the binary driving method. Alternatively, the input image determination unit 210 may calculate address power consumption through the number of times switching would be performed by the address electrode driver 300 to apply address pulses to the plurality of A electrodes when using the binary driving method.

In detail, the input image determination unit 210 converts a video signal of at least one field into subfield data, which are on/off data for each subfield, using a binary driving method that is shown in FIGS. 6 and 7. For example, the input image determination unit 210 converts a video signal of gray level 100 into 8-bit data “01100100.”

In “01100100,” digits of “0” or “1” sequentially correspond to eight subfields SF1-SF8. “0” indicates that a discharge cell is an off cell in a corresponding subfield, and “1” indicates that a discharge cell is an on cell in a corresponding subfield.

Thereafter, the input image determination unit 210 calculates address power consumption through a value in which the difference between subfield data of two adjacent discharge cells in an extending direction of the A electrode, i.e., in a column direction, is added in all discharge cells for all subfields.

In this case, the input image determination unit 210 may determine address power consumption by direct calculation through the input video signal, as described above, or may determine address power consumption by referencing a table storing different calculated results and, when a video signal is input, comparing the input video signal against the table.

The driving method selection unit 220 determines whether address power consumption is greater than or less than a threshold value. If address power consumption is greater than the threshold value, the driving method selection unit 220 selects the contiguous driving method. If address power consumption is less than the threshold value, the driving method selection unit 220 selects the binary driving method.

The driving controller 230 generates subfield data for each subfield by mapping a video signal to a plurality of subfields according to a driving method that is selected by the driving method selection unit 220. The driving controller 230 generates a driving control signal for driving the plasma display device according to the generated subfield data and outputs the driving control signal to each of the drivers 300, 400, and 500.

In another exemplary embodiment, when driving an image having high address power consumption, by selecting a contiguous driving method, address power consumption may be reduced, and when driving an image having low address power consumption, by selecting a binary driving method, a wider range of gray levels may be expressed.

In an exemplary embodiment, in order to supply priming particles to off cells, a period (e.g., period S12/S12′) in which the voltage of the Y electrodes gradually increases from the voltage Vs1 or 0V to the voltage Vs2, and a period S14 in which the voltage of the Y electrodes gradually decreases from the voltage Vs3 to the voltage V1, are provided in a sustain period. However, as described above, in a binary driving method, because priming particles can be supplied in a reset period, these periods may be unnecessary. Therefore, when the binary driving method and the contiguous driving method are selectively employed, if the PDP 100 is a panel in which many priming particles are supplied to the discharge cells, or at least in which priming particles are sufficiently discharged in discharge cells, in a driving waveform of FIGS. 4 to 7, a period of supplying priming particles may not be utilized.

In this way, according to exemplary embodiments, heat emission and/or a dynamic false contour due to address power consumption and address switching may be reduced, and the contrast ratio may be improved.

In addition, according to exemplary embodiments, a write discharge may be stably generated in an off cell.

Further, according to an exemplary embodiment, by selectively using a plurality of driving methods according to a video signal, address power consumption may be reduced and a wider range of gray levels may be expressed.

While this invention has been described in connection with what are presently considered to be practical exemplary embodiments, it is to be understood that the invention is not limited to the disclosed embodiments, but is instead intended to cover various modifications and equivalent arrangements included within the spirit and scope of the appended claims.

What is claimed is:

1. A method of driving a plasma display device comprising a plurality of discharge cells, in which one field comprises a plurality of subfields including a first subfield and a plurality of second subfields after the first subfield, the method comprising:
selecting a first driving method or a second driving method according to a video signal; and
driving the plasma display device according to the selected driving method,
wherein the first driving method comprises:
selecting first on cells from among the plurality of discharge cells in an address period of the first subfield; and
selecting second on cells in an address period of each of the plurality of second subfields from among the plurality of discharge cells other than discharge cells selected as on cells in preceding subfields of the corresponding field, and
wherein the second driving method comprises:
initializing the plurality of discharge cells as off cells in a reset period of each of the plurality of subfields; and
selecting on cells from among the plurality of discharge cells in an address period of each of the plurality of subfields following the corresponding reset period.

2. The method of claim 1, wherein the selecting the first driving method or the second driving method comprises:
determining an address power consumption of the video signal;
selecting the first driving method when the address power consumption is greater than a threshold value; and
selecting the second driving method when the address power consumption is less than the threshold value.

3. The method of claim 2, wherein the address power consumption comprises address power to be consumed when driving the video signal with the second driving method.

4. The method of claim 1, wherein the first driving method further comprises:
initializing the plurality of discharge cells as off cells in a reset period of the first subfield;
sustain-discharging the first on cells in a sustain period of the first subfield; and
in a sustain period of each of the plurality of second subfields, sustain-discharging the on cells from preceding subfields of the corresponding field and the second on cells selected in the address period of the corresponding subfield, and
wherein the second driving method further comprises in a sustain period of each subfield, sustain-discharging the on cells selected in the address period of the corresponding subfield.

5. The method of claim 4, wherein the first driving method further comprises:
discharging off cells in a sustain period of the first subfield; and
discharging off cells in a sustain period of each of the second subfields.

6. A method of driving a plasma display device comprising a plurality of first electrodes, a plurality of second electrodes, and a plurality of discharge cells aligned with the first electrodes and the second electrodes, the method comprising:
selecting first on cells from among the plurality of discharge cells in an address period of a first subfield of a first field, the first field comprising the first subfield and a plurality of second subfields after the first subfield;
sustain-discharging the first on cells in a sustain period of the first subfield;
selecting second on cells in an address period of each of the plurality of second subfields from among the plurality of discharge cells other than discharge cells selected as on cells in preceding subfields of the first field; and
in a sustain period of each of the plurality of second subfields, sustain-discharging on cells from preceding subfields and the second on cells selected in the address period of the corresponding subfield,
wherein the sustain-discharging comprises:
applying a first high-level voltage to the second electrodes while applying a first low-level voltage to the first electrodes during a first period; and
gradually increasing a voltage of the second electrodes from a first voltage to a second voltage higher than the first high-level voltage while applying the first low-level voltage to the first electrodes during a second period after the first period.

7. The method of claim 6, wherein the sustain-discharging further comprises:
alternately applying the first low-level voltage and a second high-level voltage higher than the first low-level voltage to the first electrodes during a third period before the first period; and
alternately applying the first high-level voltage and a second low-level voltage lower than the first high-level voltage to the second electrodes during the third period.

8. The method of claim 7, wherein the first voltage is equal to the second low-level voltage.

9. The method of claim 6, wherein the sustain-discharging further comprises:
applying a second high-level voltage higher than the first low-level voltage to the first electrodes and applying a second low-level voltage lower than the first high-level voltage to the second electrodes during a third period after the second period; and
gradually decreasing a voltage of the second electrodes from a fourth voltage to a fifth voltage lower than the second low-level voltage while applying a third voltage higher than the first low-level voltage to the first electrodes during a fourth period after the third period.

10. The method of claim 9, wherein the fourth voltage is equal to the first high-level voltage.

11. The method of claim 6, wherein the first voltage is equal to the first high-level voltage.

12. The method of claim 6, further comprising initializing the plurality of discharge cells before selecting the first on cells in the first subfield.

13. The method of claim 6, wherein in the first field, a weight value of the first subfield is greater than a weight value of each of the plurality of second subfields.

14. The method of claim 6, wherein in the first field, the plurality of subfields are arranged in order of descending weight value.

15. The method of claim 6, further comprising, in a second field comprising a plurality of third subfields:
initializing the plurality of discharge cells as off cells in a reset period of each of the plurality of third subfields;
selecting on cells from among the plurality of discharge cells in an address period of each of the plurality of third subfields following the reset period of the corresponding subfield; and
in a sustain period of each of the plurality of third subfields, sustain-discharging the on cells selected in the address period of the corresponding subfield.

16. The method of claim 15, wherein a video signal of the first field has higher address power consumption than a video signal of the second field.

17. A plasma display device comprising:
a plurality of first electrodes;
a plurality of second electrodes;
a plurality of discharge cells aligned with the first electrodes and the second electrodes;
a controller for dividing one field into a plurality of subfields including a first subfield and a plurality of second subfields after the first subfield, and for selecting a first driving method or a second driving method according to a video signal; and
at least one driver for driving the first electrodes and the second electrodes according to the selected driving method,
wherein, when the first driving method is selected, the at least one driver is configured to select on cells from among the plurality of discharge cells after initializing the plurality of discharge cells as off cells in the first subfield, and to select on cells in each of the plurality of second subfields from among the plurality of discharge cells other than discharge cells selected as on cells in preceding subfields of the corresponding field, and
wherein, when the second driving method is selected, the at least one driver is configured to select on cells from among the plurality of discharge cells after initializing the plurality of discharge cells as off cells in each of the plurality of subfields.

18. The plasma display device of claim 17, wherein the controller is configured to determine an address power consumption of the video signal, to select the first driving method when the address power consumption is greater than a threshold value, and to select the second driving method when the address power consumption is less than the threshold value.

19. The plasma display device of claim 17, wherein, when the first driving method is selected, the at least one driver is configured to sustain-discharge the on cells of each corresponding subfield of the plurality of subfields by applying a first high-level voltage to the second electrodes while applying a first low-level voltage to the first electrodes during a first period, and to gradually increase a voltage of the second electrodes from a first voltage to a second voltage higher than the first high-level voltage while applying the first low-level voltage to the first electrodes during a second period after the first period.

20. The plasma display device of claim 19, wherein, when the first driving method is selected, the at least one driver is further configured to sustain-discharge the on cells of each corresponding subfield of the plurality of subfields by applying a second high-level voltage higher than the first low-level voltage to the first electrodes while applying a second low-level voltage lower than the first high-level voltage to the second electrodes during a third period after the second period, and to gradually decrease a voltage of the second electrodes from a third voltage to a fourth voltage lower than the second low-level voltage while applying a fifth voltage higher than the first low-level voltage to the first electrodes during a fourth period after the third period.
